(19) United States
(12) Patent Application Publication
(10) Pub. No.: US 2025/0106839 A1
(43) Pub. Date: Mar. 27, 2025

(54) ENHANCEMENT OF UPLINK TRANSMISSION WITH SURVIVIAL TIME OR DELAY SENSITIVE REQUIREMENT

(71) Applicant: QUALCOMM Incorporated, San Diego, CA (US)

(72) Inventors: Luanxia Yang, Beijing (CN); Changlong Xu, Beijing (CN); Jing Sun, San Diego, CA (US); Xiaoxia Zhang, San Diego, CA (US); Hao Xu, Beijing (CN)

(21) Appl. No.: 18/002,446

(22) PCT Filed: Sep. 2, 2020
(86) PCT No.: PCT/CN2020/113031

§ 371 Date: Dec. 19, 2022

(51) Int. Cl. H04W 72/1268; H04L 47/28; H04W 72/566

(52) U.S. Cl. CPC H04W 72/1268; H04L 47/28; H04W 72/566

(57) ABSTRACT

Enhancement of uplink transmissions with survival time or delay sensitive data is discussed. A set of time sensitive resources is preconfigured for one or more user equipment (UEs). A serving base station communicates an identification of the configured time sensitive resources to the UEs. Upon detection of time sensitive data for transmission, a UE may send a time sensitive scheduling request to the base station that indicates the UE will be transmitting time sensitive data on the configured resources. When shared amount multiple UEs, the serving base station may send availability signals to the other UEs when the configured time sensitive resources are being used by another UE and when the configured resources are available again. Other aspects and features are also claimed and described.

### TECHNICAL FIELD

Aspects of the present disclosure relate generally to wireless communication systems, and more particularly, to uplink transmission operations. Certain embodiments of the technology discussed below can enable and provide enhancement of uplink transmissions with survival time or delay sensitive data.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes receiving, at a UE, a resource configuration from a serving base station, wherein the resource configuration configures configured time sensitive uplink resources, determining, by the UE, a time sensitive data for transmission, and autonomously transmitting, by the UE, the time sensitive data using the configured time sensitive uplink resources.

In an additional aspect of the disclosure, a method of wireless communication includes configuring, by a base station, one or more configured time sensitive uplink resources for time sensitive transmission, transmitting, by the base station, a configuration signal to at least one served UE, wherein the configuration signal includes identification of the one or more configured time sensitive uplink resources, receiving, by the base station, a time sensitive scheduling request from at least one served UE, wherein the time sensitive scheduling request indicates the at least one served UE will transmit time sensitive data on the one or more configured time sensitive uplink resources, and receiving, by the base station, the time sensitive data transmitted by the at least one served UE on the one or more configured time sensitive uplink resource.

In an additional aspect of the disclosure, an apparatus configured for wireless communication includes means for receiving, at a UE, a resource configuration from a serving base station, wherein the resource configuration configures configured time sensitive uplink resources, means for determining, by the UE, a time sensitive data for transmission, and means for autonomously transmitting, by the UE, the time sensitive data using the configured time sensitive uplink resources.

In an additional aspect of the disclosure, an apparatus configured for wireless communication includes means for configuring, by a base station, one or more configured time sensitive uplink resources for time sensitive transmission, means for transmitting, by the base station, a configuration signal to at least one served UE, wherein the configuration signal includes identification of the one or more configured time sensitive uplink resources, means for receiving, by the base station, a time sensitive scheduling request from at least one served UF, wherein the time sensitive scheduling request indicates the at least one served UE will transmit time sensitive data on the one or more configured time sensitive uplink resources, and means for receiving, by the base station, the time sensitive data transmitted by the at least one served UE on the one or more configured time sensitive uplink resource.

In an additional aspect of the disclosure, a non-transitory computer-readable medium having program code recorded thereon. The program code further includes code to receive, at a UE, a resource configuration from a serving base station, wherein the resource configuration configures configured time sensitive uplink resources, code to determine, by the UE, a time sensitive data for transmission, and code to autonomously transmit, by the UE, the time sensitive data using the configured time sensitive uplink resources.

In an additional aspect of the disclosure, a non-transitory computer-readable medium having program code recorded thereon. The program code further includes code to configure, by a base station, one or more configured time sensitive uplink resources for time sensitive transmission, code to transmit, by the base station, a configuration signal to at least one served UE, wherein the configuration signal includes identification of the one or more configured time sensitive uplink resources, code to receive, by the base station, a time sensitive scheduling request from at least one served UE, wherein the time sensitive scheduling request indicates the at least one served UE will transmit time sensitive data on the one or more configured time sensitive uplink resources, and code to receive, by the base station, the time sensitive data transmitted by the at least one served UE on the one or more configured time sensitive uplink resource.

In an additional aspect of the disclosure, an apparatus configured for wireless communication is disclosed. The apparatus includes at least one processor, and a memory coupled to the processor. The processor is configured to receive, at a UE, a resource configuration from a serving base station, wherein the resource configuration configures configured time sensitive uplink resources, to determine, by the UE, a time sensitive data for transmission, and to autonomously transmit, by the UE, the time sensitive data using the configured time sensitive uplink resources.

In an additional aspect of the disclosure, an apparatus configured for wireless communication is disclosed. The apparatus includes at least one processor, and a memory coupled to the processor. The processor is configured to configure, by a base station, one or more configured time sensitive uplink resources for time sensitive transmission, to transmit, by the base station, a configuration signal to at least one served UE, wherein the configuration signal includes identification of the one or more configured time sensitive uplink resources, to receive, by the base station, a time sensitive scheduling request from at least one served UE, wherein the time sensitive scheduling request indicates the at least one served UE will transmit time sensitive data on the one or more configured time sensitive uplink resources, and to receive, by the base station, the time sensitive data transmitted by the at least one served UE on the one or more configured time sensitive uplink resource.

Other aspects, features, and embodiments will become apparent to those of ordinary skill in the art, upon reviewing the following description of specific, exemplary embodiments in conjunction with the accompanying figures. While features may be discussed relative to certain aspects and figures below, all embodiments can include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system according to some embodiments of the present disclosure.

FIG. 2 is a block diagram conceptually illustrating a design of a base station and a UE configured according to some embodiments of the present disclosure.

FIG. 3 is a block diagram illustrating a wireless network including a base station and UE configured for a standard uplink scheduling procedure.

FIGS. 4A and 4B are block diagrams illustrating example blocks executed to implement one aspect of the present disclosure.

FIG. 5 is a block diagram illustrating a wireless network in which a base station and UE are configured for configured time sensitive uplink transmission according to one aspect of the present disclosure.

FIG. 6 is a block diagram illustrating a wireless network having a base station and UEs configured for time sensitive transmission scheduling according to aspects of the present disclosure.

FIGS. 7A and 7B are block diagrams illustrating a wireless network having a base station and UE configured for time sensitive transmission scheduling according to aspects of the present disclosure.

FIG. 8 is a block diagram conceptually illustrating a design of a UE configured for configured time sensitive uplink transmission according to some embodiments of the present disclosure.

FIG. 9 is a block diagram conceptually illustrating a design of a base station configured for configured time sensitive uplink transmission according to some embodiments of the present disclosure.

The Appendix provides further details regarding various embodiments of this disclosure and the subject matter therein forms a part of the specification of this application.

### DETAILED DESCRIPTION

The detailed description set forth below, in connection with the appended drawings and appendix, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The Third Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with Universal Terrestrial Radio Access Networks (UTRANs) in the case of a UMTS/GSM network. Additionally, an operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects descried with reference to one technology may be understood to be applicable to another technology. Indeed, one or more aspects of the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. In some practical settings, devices incorporating described aspects and features may also necessarily include additional components and features for implementation and practice of claimed and described embodiments. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

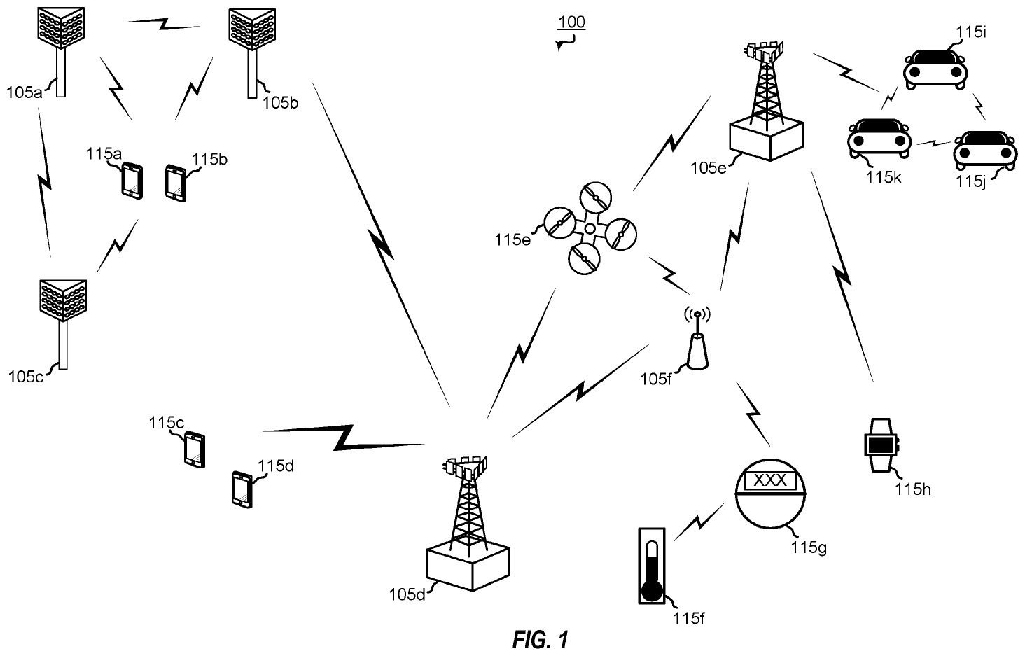

FIG. 1 is a block diagram illustrating details of an example wireless communication system. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component device/module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink and/or uplink, or desired transmission between base stations, and backhaul transmissions between base stations. UEs may operate as base stations or other network nodes in some scenarios. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

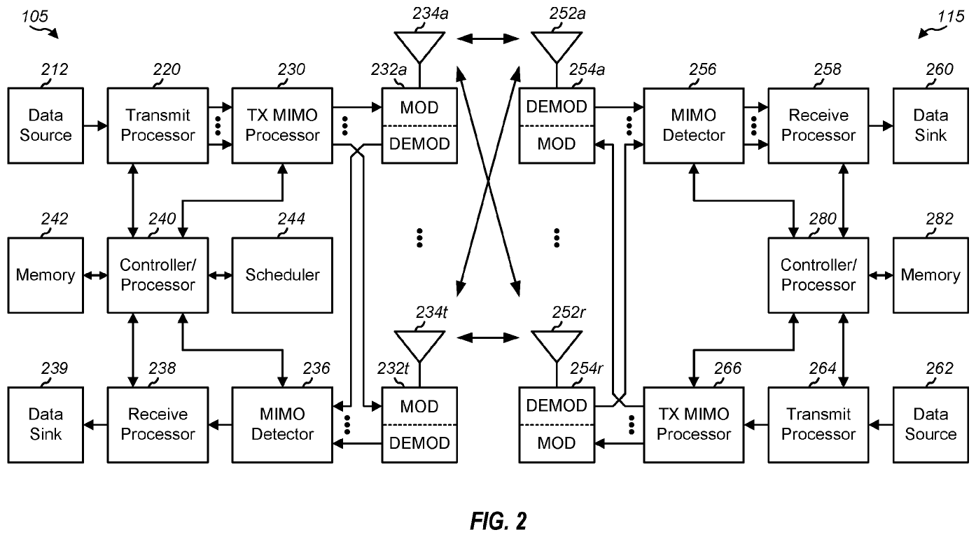

FIG. 2 shows a block diagram conceptually illustrating an example design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols. the control symbols, and/or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, the antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller/processor 280.

On the uplink, at UE 115, transmit processor 264 may receive and process data (e.g., for the physical uplink shared channel (PUSCH)) from data source 262 and control information (e.g., for the physical uplink control channel (PUCCH)) from controller/processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Processor 238 may provide the decoded data to data sink 239 and the decoded control information to controller/processor 240.

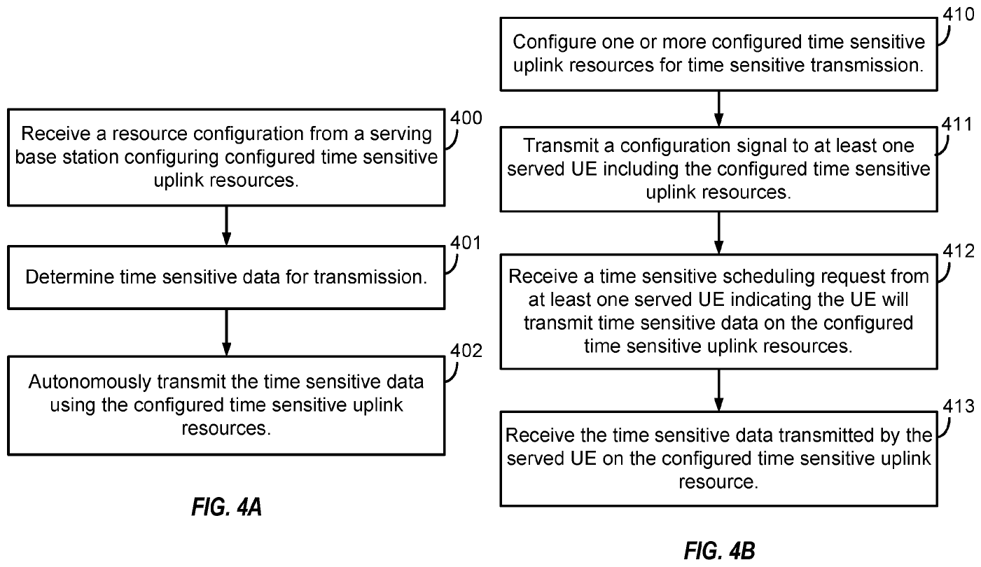

Controllers/processors 240 and 280 may direct the operation at base station 105 and UE 115, respectively. Controller/processor 240 and/or other processors and modules at base station 105 and/or controller/processor 280 and/or other processors and modules at UE 115 may perform or direct the execution of various processes for the techniques described herein, such as to perform or direct the execution illustrated in FIGS. 4A and 4B, and/or other processes for the techniques described herein. Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations. a CCA may include an energy detection procedure to determine whether there are any other active transmissions For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

Certain uplink data may be subject to a time sensitivity, such as a survival time or delay sensitivity. Survival time can be expressed as a period of time or, especially with cyclic traffic, as maximum number of consecutive incorrectly received or lost messages. When the survival time has been exceeded, the application using the data would transition the status of the communication service into a down state. Current wireless standards provide several definitions of survival time that may be classified into two types: generic definitions and specific requirements. The generic definitions may provide a general window over which transmissions should be successfully received, while the more stringent definitions may actually relate the survival time to the transfer interval.

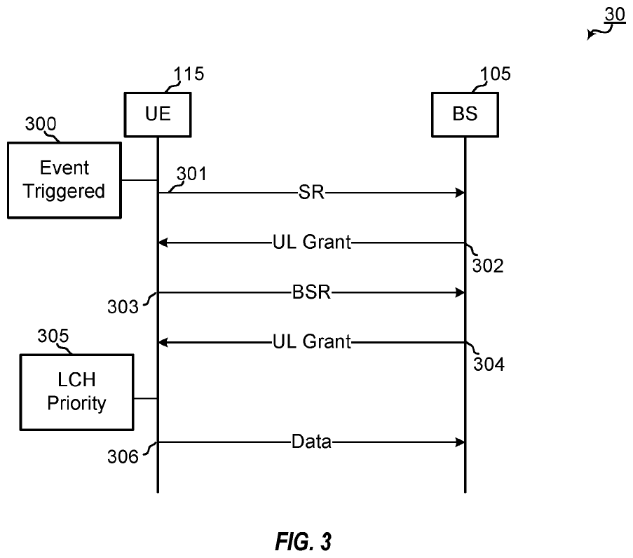

FIG. 3 is a block diagram illustrating a wireless network 30 including a base station 105 and UE 115 configured for a standard uplink scheduling procedure. The standard uplink scheduling procedure includes a scheduling request (SR) 301 after an uplink transmission event 300 is triggered at UE 115 transmitted to base station 105 as a request for uplink channel resource scheduling for a new transmission. Each SR configuration corresponds to one or more logical channels, while each logical channel may be mapped to zero or one SR configurations, which are configured by base station 105 via radio resource control (RRC) signaling. If more than one SR is triggered simultaneously, uplink resource may be allocated based on the logical channel prioritization. For each SR, the associated RRC message configures a set of parameters for the scheduling request procedure, such as the an SR timer for SR transmission on an uplink control channel (e.g., sr-ProhibitTimer) and a maximum number of SR transmissions (e.g., sr-TransMax). When the SR timers is running, the medium access control (MAC) entity may not perform SR transmissions.

Once UE 115 transmits the initial SR, SR 301, for uplink resource scheduling, base station 105 responds with an uplink grant 302 that schedules the resources for transmission of buffer status report (BSR) 303. UF 115 transmits BSR 303 using the scheduled resources to base station 105. Base station 105 determines resources to be used for the uplink transmission by UE 115 and transmits uplink grant 304 to UE 115 configuring the resources for the uplink transmissions. UE 105 may then determine channel priority and multiplexing at 305 for the transmission channel and then transmits uplink data 306 using the configured uplink resources.

One issues that may arise is when UE 115 has time sensitive data available for transmission. Such time sensitive data may include data subject to a survival time limitation or some other delay sensitivity requirement. The standard uplink scheduling procedures includes multiple transmissions back and forth between UE 115 and base station 105 before UE 115 has been configured with the resources for transmitting the uplink data. If the uplink data package is subject to a time sensitive restriction survival time requirement, there may be a question as to how UE 115 may inform base station 105 that the data is time sensitive and should be transmitted as soon as possible. UE 115 could potentially report some specific signal to base station 105 that informs base station 105 that UE 115 has some data subject to a time sensitive requirement and requests an urgent uplink resource allocation. Base station 105 may then provide such uplink resource based on the indication. Instead of such request process, the various aspects of the present disclosure are directed to a pre-configuration of time sensitive resources that a UE may be able to autonomously use to transmit time sensitive data without request a separate uplink grant from the serving base station.

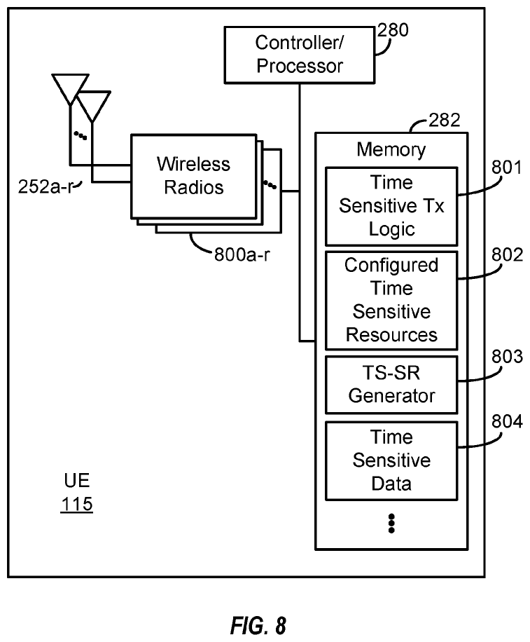

FIG. 4A is a block diagram illustrating example blocks executed to implement one aspect of the present disclosure. The example blocks will also be described with respect to UE 115 as illustrated in FIG. 8. FIG. 8 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 800a-r and antennas 252a-r. Wireless radios 800a-r includes various components and hardware, as illustrated in FIG. 2 for UE 115, including modulator/demodulators 254a-r, MIMO detector 256, receive processor 258, transmit processor 264, and TX MIMO processor 266.

At block 400, a UE receives a resource configuration from a serving base station, wherein the resource configuration configures configured time sensitive uplink resources. According to the various aspects of the present disclosure, UEs, such as UE 115, may be configured for time sensitive transmission operations. In order to implement the functionality for such operations, UE 115, under control of controller/processor 280. executes time sensitive transmission logic 801, stored in memory 282. The functionality and operations enabled through execution of the instructions and steps of time sensitive transmission logic 801 (referred to herein as the “execution environment” of time sensitive transmission logic 801) allow for UE 115 to conduct the time sensitive transmissions according to the various aspects herein. UE 115 may receive a configuration message from a serving base station via antennas 252a-r and wireless radios 800a-r. The configuration message identifies configured time sensitive uplink resources that UE 115 may use for autonomous transmissions of time sensitive data 804 and stores identification of such resources in memory 282 at configured time sensitive resources 802.

At block 401, the UE determines a time sensitive data for transmission. UE 115 identifies that it has time sensitive data 804, stored in memory 282, ready for transmission. Within the execution environment of time sensitive transmission logic 801, UE 115 determines the process to follow for such transmission.

At block 402, the UE autonomously transmits the time sensitive data using the configured time sensitive uplink resources. Within the execution environment of time sensitive transmission logic 801, once UE 115 determines that it has data for transmission in time sensitive data 804, it may autonomously transmit time sensitive data 804 via wireless radios 800a-r and antennas 252a-r using the configured resources in configured time sensitive resources 802. In selected aspects, prior to autonomously transmitting the data in time sensitive data 804, UE 115, within the execution environment of time sensitive transmission logic 801, may initiate TS-SR generator 803 to generate a time sensitive scheduling request (TS-SR) for transmission to the serving base station. In such aspects, the transmitted TS-SR provides notice to the serving base station that UE 115 will be transmitting on the configured resources.

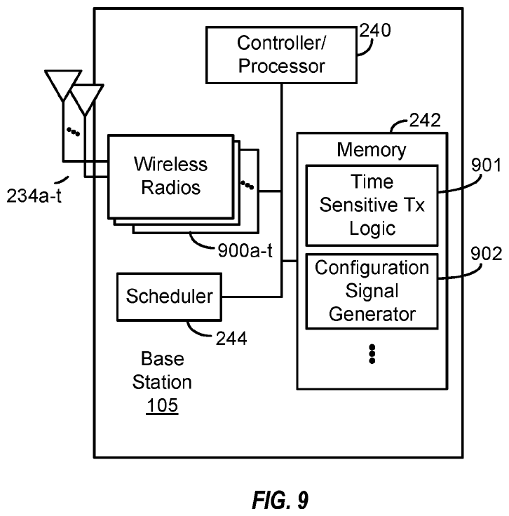

FIG. 4B is a block diagram illustrating example blocks executed by a base station to implement on aspect of the present disclosure. The example blocks will also be described with respect to base station 105 as illustrated in FIG. 9. FIG. 9 is a block diagram illustrating base station 105 configured according to one aspect of the present disclosure. Base station 105 includes the structure, hardware, and components as illustrated for base station 105 of FIG. 2. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 900a-t and antennas 234a-t. Wireless radios 900a-t includes various components and hardware, as illustrated in FIG. 2 for base station 105, including modulator/demodulators 232a-t, MIMO detector 236, receive processor 238, transmit processor 220, and TX MIMO processor 230.

At block 410, a base station configures one or more configured time sensitive uplink resources for time sensitive transmission. In order to implement the functionality for such operations, base station 105, under control of controller/processor 240, executes time sensitive transmission logic 901, stored in memory 242. The functionality implemented through the execution environment of time sensitive transmission logic 901 allows for base station 105 to conduct the time sensitive transmissions according to the various aspects herein. Base station 105, under control of controller/processor 240, operates scheduler 244 to schedule configured resources for time sensitive transmissions.

At block 411, the base station transmits a configuration signal to at least one served UE, wherein the configuration signal includes identification of the one or more configured time sensitive uplink resources. Within the execution environment of time sensitive transmission logic 901, base station 105 executes configuration signal generator 902 to generate a configuration signal that identifies the configured time sensitive uplink resources for the served UEs. Base station 105 may then transmit the configuration signal via wireless radios 900a-t and antennas 234a-t.

At block 412, the base station receives a time sensitive scheduling request from at least one served UE, wherein the time sensitive scheduling request indicates the at least one served UE will transmit time sensitive data on the one or more configured time sensitive uplink resources. Base station 105 may receive a time sensitive scheduling request (TS-SR) from a served UE indicating that the UE will be using the configured time sensitive uplink resources for transmission. Base station 105 receives such TS-SR via antennas 234a-t and wireless radios 900a-t. Base station 105 uses the TS-SR to know to expect to receive transmissions on the configured resources.

At block 413, the base station receives the time sensitive data transmitted by the at least one served UE on the one or more configured time sensitive uplink resource. After receiving the TS-SR, base station 105 may then receive the time sensitive transmissions from the signaling UE on the configured time sensitive resources. Base station 105 receives such data via antennas 234a-t and wireless radios 900a-t. The time sensitive nature of the data prompts base station 105 to handle such data with a time sensitive priority.

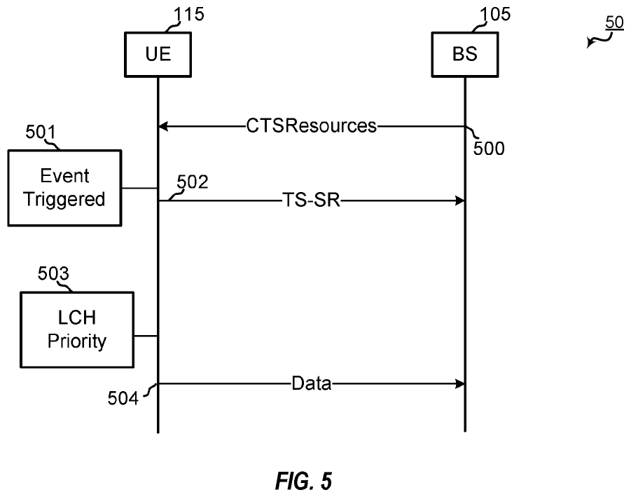

FIG. 5 is a block diagram illustrating a wireless network 50 in which base station 105 and UE 115 are configured for configured time sensitive uplink transmission according to one aspect of the present disclosure. A base station, such as base station 105, may preconfigure the resource for time sensitive data transmissions and signal configuration of the resources to UE 115 via a configuration message, such as configured time sensitive resources (CTSResources) message 500. Such a configuration may be signaled via RRC messaging. As UE 115 detects event 501 triggering time sensitive data for transmission, UE 115 may transmit a time sensitive SR (TS-SR) 502 to base station 105 and then autonomously uses the configured time sensitive resources for transmission of time sensitive data 504 after determining the logical channel priority and performing any multiplexing, at 503, onto the resources. TS-SR 502 may include a special SR request configured for time sensitive transmissions, a BSR, or the like, which informs base station 105 that the configured time sensitive resources will be used for transmitting time sensitive data.

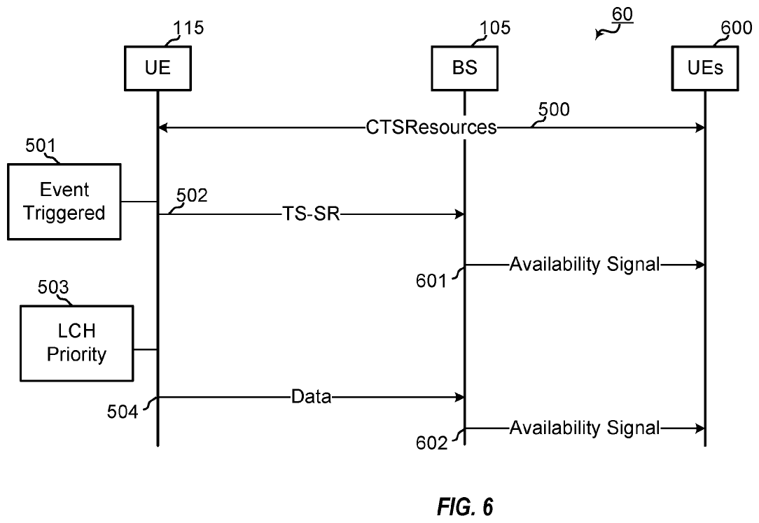

FIG. 6 is a block diagram illustrating a wireless network 60 having base station 105 and UEs 115 and 600 configured for time sensitive transmission scheduling according to aspects of the present disclosure. In addition to configuring the time sensitive resources for UE 115, as depicted in FIG. 5, the time sensitive resources may be configured for a number of UEs served by base station 105. As illustrated in FIG. 6, base station 105 serves UE 115 and one or more other UEs, identified as UEs 600. As described in FIG. 5, base station 105 transmits configuration of CTSResources 500 to each of UE 115 and UEs 600. Such CTSResources message 500 may identify a single designed resource for time sensitive transmissions to be shared by UEs 115 and 600, a pool of resources shared by UEs 115 and 600 and determined according to a hashing scheme, or a set of resources that base station 105 may assist in selecting.

In a first optional aspect, each of UEs 115 and 600 may be configured with a single resource identified in CTSResources message 500 that is shared by UEs 115 and 600. As UE 115 detects an event trigger 501 that indicates time sensitive data for transmission, UE 115 transmits TS-SR 502 to base station 105 and then, after determining the logical channel priority and multiplexing at 503, may transmit time sensitive data 504 on the configured resources identified by CTSResources message 500. Because the configured resource is shared among UEs 115 and 600, there may be opportunities for collision when multiple UEs attempt to transmit time sensitive data on the same configured resources. In order to handle any collision, various aspects of the present disclosure provide for options to resolve such collisions. In a first option aspect for collision avoidance, when base station 105 receives TS-SR 502 from UE 115, it transmits an availability signal 601 to the other UEs, UEs 600, sharing the configured resource. Such availability signal 601 indicates to UEs 600 that the configured resource is occupied by UE 115 and, thus, not available. Once UE 115 finishes transmission of time sensitive data 504, base station 105 may send a further signal, availability signal 602, to UEs 600 to indicate the configured resource is now available. During the time between availability signal 601, where base station 105 informs UEs 600 that the configured time sensitive resource is not available, and availability signal 602, where base station 105 informs UEs 600 that the configured resource is available again, UEs 600 may not use the configured resources for transmission of time sensitive data.

In a second optional aspect for collision avoidance, availability signal 601 from base station 105 may include an uplink grant that schedules a new resource for UEs 600. For example, a bit may be added to this uplink grant to indicate the resource is unavailable or released. In one example implementation, a 0 may mean the resource is unavailable, and 1 may mean the resource is released and UEs 600 can use the resource to transmit any time sensitive data.

In a third optional aspect for collision avoidance, availability signal 601 from base station 105 may include an uplink grant that allocates a new resource for UEs 600 and may automatically cancel the original configured time sensitive resources (CTSResources message 500) for UEs 600.

In a fourth optional aspect for collision avoidance, availability signal 601 from base station 105 may be a common control signal (e.g., group common (GC)-PDCCH) to UEs 600 that informs UEs 600 that the configured resources are either unavailable or released.

In an additional aspect, where UEs 600 may include only one or two additional UEs, the configured time sensitive resource may be shared by each of UE 115 and 600, but specifically designated for one of the UEs, such as UE 115. Where a collision occurs in such an aspect, the configured time sensitive resource may be used on a first-come, first-serve basis, when UEs 115 and 600 are transmitting at different times, or according to the UE with the highest priority for access to the configured resource. In such a collision, UE 115 would have priority to access the configured time sensitive resource over UEs 600. Priority may also be determined according to logical channel priority or channel access priority class (CAPC) of UEs 115 and 600.

As noted above, the configured time sensitive resources (CTSResources message 500) may be configured as a resource pool of multiple candidate resources for time sensitive transmissions. In such example aspect, UEs 115 and 600 would use a hash to randomly or pseudo-randomly select one of the resources of the resource pool. For example, UE 115, after detecting the event triggering a transmission of time sensitive data, may apply a hash to selected one of the pre-configured time sensitive resources of the resource pool. Both UE 115 and base station 105 will know this hash so that base station 105 will also know which of the configured time sensitive resources UE 115 will be transmitting on.

It should be noted that, as the pool of resources may also be shared between UEs 115 and 600, there may be a possibility for a collision to occur when two or more UEs of UEs 115 and 600 hash to the same configured resource. If such a collision occurs, the different optional aspects for collision avoidance may be used for resolving any potential collision where a pool of resources is used for the configured time sensitive resources (CTSResources message 500).

As further noted above, UEs may be preconfigured with a set of configured time sensitive resources. In such example aspect, a serving base station may assist in resource overloading. In such an example aspect, the serving base station may send an indicator to help the UE figure out if it should use the configured resource or not. Each UE would be configured with a set of resources, potentially overlapping with other UEs' configured resource. The serving base station may dynamically provide the indication of whether the configured resources can be used or not. Such an indication may be implemented explicitly, such as via an RRC or downlink control information (DCI) message or implicitly, such as via a downlink trigger.

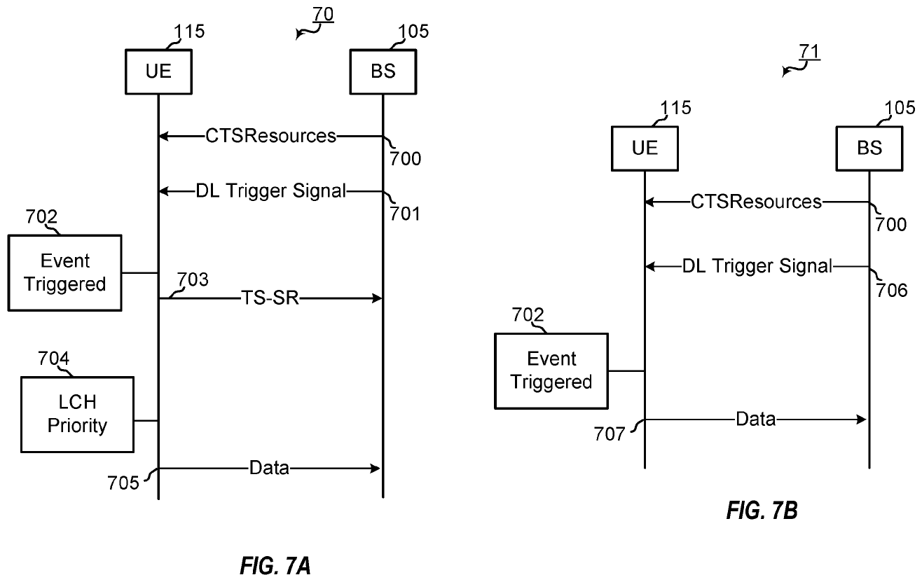

FIG. 7A is a block diagram illustrating a wireless network 70 having a base station 105 and UE 115 configured for time sensitive transmission scheduling according to one aspect of the present disclosure. Base station 105 configures its served UEs, including UE 115, with a set of configured time sensitive resources. Base station 105 transmits a configuration signal, CTSResources message 700, that identifies the set of configured time sensitive resources for UE 115. As noted above, in the illustrated aspect, UE 115 may be configured with a set of configured resources that may overlap with other resources used for configured time sensitive resources for any neighboring UEs. Base station 105 may transmit a group downlink trigger signal, downlink trigger signal 701, to identify a time sensitive resource. Each downlink trigger signal may correspond to a particular resource within the set of configured time sensitive resources. If UE 115 detects that downlink trigger signal 701 is associated with one of the resources of its set of configured time sensitive resources, UE 115 may use that resource for transmissions. For example, upon detecting an event 702 triggering transmission of time sensitive data, UE 115, having detected downlink trigger signal 701 associated with one of the resources in its set of configured time sensitive resources, uses that resource to transmit time sensitive data 706 after determining channel priority and multiplexing at 704. Downlink trigger signal 701 can be configured as a waveform-based design or can be a downlink control channel transmission (e.g., PDCCH). Downlink trigger signal 701 may also be transmitted via a frequency division multiplex (FDM) scheme with a synchronization signal burst (SSB) transmission.

FIG. 7B is a block diagram illustrating a wireless network 70 having a base station 105 and UE 115 configured for time sensitive transmission scheduling according to one aspect of the present disclosure. Base station 105 configures its served UEs, including UE 115, with a set configured time sensitive resources identified via configuration signal, CTSResources message 700. As noted above, in the illustrated aspect, UE 115 may be configured with a set of configured resources that may overlap with other resources used for configured time sensitive resources for any neighboring UEs. Base station 105 may transmit downlink trigger signal 706. In the example aspect illustrated in FIG. 7B, downlink trigger signal 706 is UE-specific. Thus, base station 105 transmits downlink trigger signal 706 directly to UE 115. With the direct transmission of downlink trigger signal 706, UE 115 may immediately use the configured time sensitive resource to transmit time sensitive data 707 without first transmitting a TS-RS, as base station 105 knows the selected resource identified in downlink trigger signal 706.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and modules described herein (e.g., the components, functional blocks, and modules in FIG. 2) may comprise processors, electronics devices, hardware devices, electronics components, logical circuits, memories, software codes, firmware codes, etc., or any combination thereof. In addition, features discussed herein relating to enhancement of uplink transmissions with survival time or delay sensitive data may be implemented via specialized processor circuitry, via executable instructions, and/or combinations thereof.

Those of skill would further appreciate that the various illustrative logical blocks, modules, circuits, and algorithm steps (e.g., the logical blocks in FIGS. 4A and 4B) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various aspects of the present disclosure may be implemented in many different ways, including methods, processes, non-transitory computer-readable medium having program code recorded thereon, apparatus having one or more processors with configurations and instructions for performing the described features and functionality, and the like. A first aspect configured for wireless communication may include receiving, at a UE, a resource configuration from a serving base station, wherein the resource configuration configures configured time sensitive uplink resources; determining, by the UE, a time sensitive data for transmission; and autonomously transmitting, by the UE, the time sensitive data using the configured time sensitive uplink resources.

A second aspect, based on the first aspect, wherein the configured time sensitive uplink resources includes one of: a single shared resource shared between the UE and one or more additional UEs; a resource pool shared between the UE and the one or more additional UEs, wherein the resource pool includes a plurality of uplink resources; and a set of resources shared between the UE and the one or more additional UEs.

A third aspect, based on the second aspect, further including: transmitting, by the UE, a time sensitive scheduling request to the serving base station after the determining the time sensitive data for transmission, wherein the configured time sensitive uplink resources include one of: the single shared resource or the resource pool.

A fourth aspect, based on the second aspect, further including: receiving, at the UF, an unavailability signal from the serving base station prior to the autonomously transmitting, wherein the unavailability signal identifies the configured time sensitive uplink resources are unavailable; and refraining, by the UE, from the autonomously transmitting the time sensitive data in response to the availability signal, wherein the configured time sensitive uplink resources include one of: the single shared resource or the resource pool.

A fifth aspect, based on the fourth aspect, wherein the unavailability signal includes one of: an uplink grant identifying the configured time sensitive uplink resource is unavailable; the uplink grant scheduling a new time sensitive resource for the UE; the uplink grant scheduling the new time sensitive resource for the UE and canceling configuration of the configured time sensitive uplink resource for the UE; or a group common control signal identifying the configured time sensitive uplink resource is unavailable.

A sixth aspect, based on the fourth aspect, further including: receiving, by the UE, an availability signal from the serving base station after the refraining, wherein the availability signal indicates to the UE that the configured time sensitive resource is available for transmission, wherein the autonomously transmitting occurs after receipt of the availability signal.

A seventh aspect, based on the second aspect, further including: detecting, by the UE, a collision of transmissions scheduled with another UE sharing the configured time sensitive uplink resource, wherein the configured time sensitive uplink resource includes the single shared resource; determining, by the UE, a scheduled transmission time of the UE and the another UE; determining, by the UE, in response to the scheduled transmission time being different, first transmission on the configured time sensitive uplink resource to the one of: the UE or the another UE scheduled for an earlier transmission; and determining, by the UE, in response to the scheduled transmission time being a same time, the first transmission on the configured time sensitive uplink resource to the one of: the UE or the another UE having a higher access priority to the configured time sensitive uplink resource.

An eighth aspect, based on the second aspect, further including selecting, by the UE, a time sensitive resource from the resource pool for transmission, wherein the time sensitive resource is selected using a hashing procedure known to the serving base station.

A ninth aspect, based on the second aspect, further including: receiving, by the UE, a downlink trigger signal prior to the autonomously transmitting; and selecting, by the UE, a time sensitive resource from the set of resources using the downlink trigger signal, wherein each of a plurality of time sensitive resources of the set of resources is associated with a corresponding downlink trigger signal.

A tenth aspect, based on the ninth aspect, wherein the downlink trigger signal includes one of: a pre-configured waveform; a downlink control signal; a FDM signal within a SSB transmission.

An eleventh aspect, based on the second aspect, further including: receiving, by the UE, a UE-specific downlink trigger signal prior to the autonomously transmitting, wherein the UE-specific downlink trigger signal identifies a time sensitive resource from the set of resources for the autonomously transmitting.

A twelfth aspect may include any combination of the first aspect through the eleventh aspect.

A thirteenth aspect configured for wireless communication may include configuring, by a base station, one or more configured time sensitive uplink resources for time sensitive transmission; transmitting, by the base station, a configuration signal to at least one served UE, wherein the configuration signal includes identification of the one or more configured time sensitive uplink resources; receiving, by the base station, a time sensitive scheduling request from at least one served UE, wherein the time sensitive scheduling request indicates the at least one served UE will transmit time sensitive data on the one or more configured time sensitive uplink resources; and receiving, by the base station, the time sensitive data transmitted by the at least one served UE on the one or more configured time sensitive uplink resource.

A fifteenth aspect, based on the thirteenth aspect, wherein the one or more time sensitive configured time sensitive uplink resources includes one of: a single shared resource shared between two or more UEs of the at least one served UE; a resource pool shared between the two or more UEs, wherein the resource pool includes a plurality of uplink resources; and a set of resources shared between the two or more UEs.

A sixteenth aspect, based on the fourteenth aspect, further including: receiving, by the base station, a time sensitive scheduling request from a transmitting UE of the at least one served UE, wherein the configured time sensitive uplink resources include one of: the single shared resource or the resource pool.

A seventeenth aspect, based on the sixteenth aspect, further including: transmitting, at the base station, an unavailability signal to one or more other UEs of the at least one UE other than the transmitting UE, wherein the unavailability signal identifies the configured time sensitive uplink resources are unavailable.

An eighteenth aspect, based on the seventeenth aspect, wherein the unavailability signal includes one of: an uplink grant identifying the configured time sensitive uplink resource is unavailable; the uplink grant scheduling a new time sensitive resource for the one or more other UEs; the uplink grant scheduling the new time sensitive resource for the one or more other UEs and canceling configuration of the configured time sensitive uplink resource for the one or more other UEs; or a group common control signal identifying to the one or more other UEs the configured time sensitive uplink resource is unavailable.

A nineteenth aspect, based on the seventeenth aspect, further including: transmitting, by the base station, an availability signal the one or more other UEs after transmission by the transmitting UE, wherein the availability signal indicates to the one or more other UEs that the configured time sensitive resource is available for transmission.

A twentieth aspect, based on the fourteenth aspect, further including: selecting, by the base station, a time sensitive resource from the resource pool for receipt of the time sensitive data, wherein the time sensitive resource is selected using a hashing procedure known to a transmitting UE of the at least one served UEs.

A twenty-first aspect, based on the fourteenth aspect, further including: transmitting, by the base station, a downlink trigger signal to the at least one served UEs identifying a time sensitive resource for the time sensitive transmission, wherein each of a plurality of time sensitive resources of the set of resources is associated with a corresponding downlink trigger signal.

A twenty-second aspect, based on the twenty-first aspect, wherein the downlink trigger signal includes one of: a pre-configured waveform; a downlink control signal; a FDM signal within a SSB transmission.

A twenty-third aspect, based on the fourteenth aspect, further including: transmitting, by the base station, a UE-specific downlink trigger signal prior to a transmitting UE of the at least one served UEs, wherein the UE-specific downlink trigger signal identifies a time sensitive resource from the set of resources for transmission of the time sensitive data by the transmitting UE.

A twenty-fourth aspect may include any combination of the fourteenth aspect through the twenty-third aspect.

A twenty-fifth aspect configured for wireless communication may include means for receiving, at a UE, a resource configuration from a serving base station, wherein the resource configuration configures configured time sensitive uplink resources; means for determining, by the UE, a time sensitive data for transmission; and means for autonomously transmitting, by the UF, the time sensitive data using the configured time sensitive uplink resources.

A twenty-sixth aspect, based on the twenty-fifth aspect, wherein the configured time sensitive uplink resources includes one of: a single shared resource shared between the UE and one or more additional UEs; a resource pool shared between the UE and the one or more additional UEs, wherein the resource pool includes a plurality of uplink resources; and a set of resources shared between the UE and the one or more additional UEs.

A twenty-seventh aspect, based on the twenty-sixth aspect, further including: means for transmitting, by the UE, a time sensitive scheduling request to the serving base station after the means for determining the time sensitive data for transmission, wherein the configured time sensitive uplink resources include one of: the single shared resource or the resource pool.

A twenty-eighth aspect, based on the twenty-sixth aspect, further including: means for receiving, at the UE, an unavailability signal from the serving base station prior to the means for autonomously transmitting, wherein the unavailability signal identifies the configured time sensitive uplink resources are unavailable; and means for refraining, by the UE, from the autonomously transmitting the time sensitive data in response to the availability signal, wherein the configured time sensitive uplink resources include one of: the single shared resource or the resource pool.

A twenty-ninth aspect, based on the twenty-eighth aspect, wherein the unavailability signal includes one of: an uplink grant identifying the configured time sensitive uplink resource is unavailable; the uplink grant scheduling a new time sensitive resource for the UE; the uplink grant scheduling the new time sensitive resource for the UE and canceling configuration of the configured time sensitive uplink resource for the UE; or a group common control signal identifying the configured time sensitive uplink resource is unavailable.

A thirtieth aspect, based on the twenty-eighth aspect, further including: means for receiving, by the UE, an availability signal from the serving base station after the means for refraining, wherein the availability signal indicates to the UE that the configured time sensitive resource is available for transmission, wherein the means for autonomously transmitting occurs after receipt of the availability signal.

A thirty-first aspect, based on the twenty-sixth aspect, further including: means for detecting, by the UE, a collision of transmissions scheduled with another UE sharing the configured time sensitive uplink resource, wherein the configured time sensitive uplink resource includes the single shared resource; means for determining, by the UE, a scheduled transmission time of the UE and the another UE; means for determining, by the UE, in response to the scheduled transmission time being different, first transmission on the configured time sensitive uplink resource to the one of: the UE or the another UE scheduled for an earlier transmission; and means for determining, by the UE, in response to the scheduled transmission time being a same time, the first transmission on the configured time sensitive uplink resource to the one of: the UE or the another UE having a higher access priority to the configured time sensitive uplink resource.

A thirty-second aspect, based on the twenty-sixth aspect, further including: means for selecting, by the UE, a time sensitive resource from the resource pool for transmission, wherein the time sensitive resource is selected using a hashing procedure known to the serving base station.

A thirty-third aspect, based on the twenty-sixth aspect, further including: means for receiving, by the UE, a downlink trigger signal prior to the means for autonomously transmitting; and means for selecting, by the UE, a time sensitive resource from the set of resources using the downlink trigger signal, wherein each of a plurality of time sensitive resources of the set of resources is associated with a corresponding downlink trigger signal.

A thirty-fourth aspect, based on the thirty-third aspect, wherein the downlink trigger signal includes one of: a pre-configured waveform; a downlink control signal; or a FDM signal within a SSB transmission.

A thirty-fifth aspect, based on the twenty-sixth aspect, further including: means for receiving, by the UE, a UE-specific downlink trigger signal prior to the means for autonomously transmitting, wherein the UE-specific downlink trigger signal identifies a time sensitive resource from the set of resources for the means for autonomously transmitting.

A thirty-sixth aspect may include any combination of the twenty-fifth aspect through the thirty-fifth aspect.

A thirty-seventh aspect configured for wireless communication may include means for configuring, by a base station, one or more configured time sensitive uplink resources for time sensitive transmission; means for transmitting, by the base station, a configuration signal to at least one served UE, wherein the configuration signal includes identification of the one or more configured time sensitive uplink resources; means for receiving, by the base station, a time sensitive scheduling request from at least one served UE, wherein the time sensitive scheduling request indicates the at least one served UE will transmit time sensitive data on the one or more configured time sensitive uplink resources; and means for receiving, by the base station, the time sensitive data transmitted by the at least one served UE on the one or more configured time sensitive uplink resource.

A thirty-eighth aspect, based on the thirty-seventh aspect, wherein the one or more time sensitive configured time sensitive uplink resources includes one of: a single shared resource shared between two or more UEs of the at least one served UE; a resource pool shared between the two or more UEs, wherein the resource pool includes a plurality of uplink resources; and a set of resources shared between the two or more UEs.

A thirty-ninth aspect, based on the thirty-eighth aspect, further including: means for receiving, by the base station, a time sensitive scheduling request from a transmitting UE of the at least one served UE, wherein the configured time sensitive uplink resources include one of: the single shared resource or the resource pool.

A fortieth aspect, based on the thirty-ninth aspect, further including: means for transmitting, at the base station, an unavailability signal to one or more other UEs of the at least one UE other than the transmitting UE, wherein the unavailability signal identifies the configured time sensitive uplink resources are unavailable.

A forty-first aspect, based on the fortieth aspect, wherein the unavailability signal includes one of: an uplink grant identifying the configured time sensitive uplink resource is unavailable; the uplink grant scheduling a new time sensitive resource for the one or more other UEs; the uplink grant scheduling the new time sensitive resource for the one or more other UEs and canceling configuration of the configured time sensitive uplink resource for the one or more other UEs; or a group common control signal identifying to the one or more other UEs the configured time sensitive uplink resource is unavailable.

A forty-second aspect, based on the fortieth aspect, further including: means for transmitting, by the base station, an availability signal the one or more other UEs after transmission by the transmitting UE, wherein the availability signal indicates to the one or more other UEs that the configured time sensitive resource is available for transmission.

A forty-third aspect, based on the thirty-eighth aspect, further including: means for selecting, by the base station, a time sensitive resource from the resource pool for receipt of the time sensitive data, wherein the time sensitive resource is selected using a hashing procedure known to a transmitting UE of the at least one served UEs.

A forty-fourth aspect, based on the thirty-eighth aspect, further including: means for transmitting, by the base station, a downlink trigger signal to the at least one served UEs identifying a time sensitive resource for the time sensitive transmission, wherein each of a plurality of time sensitive resources of the set of resources is associated with a corresponding downlink trigger signal.

A forty-fifth aspect, based on the forty-fourth aspect, wherein the downlink trigger signal includes one of: a pre-configured waveform; a downlink control signal; or a FDM signal within a SSB transmission.

A forty-sixth aspect, based on the thirty-eighth aspect, further including: means for transmitting, by the base station, a UE-specific downlink trigger signal prior to a transmitting UE of the at least one served UEs, wherein the UE-specific downlink trigger signal identifies a time sensitive resource from the set of resources for transmission of the time sensitive data by the transmitting UE.

A forty-seventh aspect may include any combination of the thirty-seventh aspect through the forty-sixth aspect.

A forty-eighth configured for wireless communication includes a non-transitory computer-readable medium having program code recorded thereon, the program code including program code executable by a computer for causing the computer to receive, at a UE, a resource configuration from a serving base station, wherein the resource configuration configures configured time sensitive uplink resources; program code executable by the computer for causing the computer to determine, by the UE, a time sensitive data for transmission; and program code executable by the computer for causing the computer to autonomously transmit, by the UE, the time sensitive data using the configured time sensitive uplink resources.

A forty-ninth aspect, based on the forty-eighth aspect, wherein the configured time sensitive uplink resources includes one of: a single shared resource shared between the UE and one or more additional UEs; a resource pool shared between the UE and the one or more additional UEs, wherein the resource pool includes a plurality of uplink resources; and a set of resources shared between the UE and the one or more additional UEs.

A fiftieth aspect, based on the forty-ninth aspect, further including: program code executable by the computer for causing the computer to transmit, by the UE, a time sensitive scheduling request to the serving base station after execution of the program code executable by the computer for causing the computer to determine the time sensitive data for transmission, wherein the configured time sensitive uplink resources include one of: the single shared resource or the resource pool.

A fifty-first aspect, based on the forty-ninth aspect, further including: program code executable by the computer for causing the computer to receive, at the LE, an unavailability signal from the serving base station prior to execution of the program code executable by the computer for causing the computer to autonomously transmit, wherein the unavailability signal identifies the configured time sensitive uplink resources are unavailable; and program code executable by the computer for causing the computer to refrain, by the UE, from execution of the program code executable by the computer for causing the computer to autonomously transmit the time sensitive data in response to the availability signal, wherein the configured time sensitive uplink resources include one of: the single shared resource or the resource pool.

A fifty-second aspect, based on the fifty-first aspect, wherein the unavailability signal includes one of: an uplink grant identifying the configured time sensitive uplink resource is unavailable; the uplink grant scheduling a new time sensitive resource for the UE; the uplink grant scheduling the new time sensitive resource for the UE and canceling configuration of the configured time sensitive uplink resource for the UE; or a group common control signal identifying the configured time sensitive uplink resource is unavailable.

A fifty-third aspect, based on the fifty-first aspect, further including: program code executable by the computer for causing the computer to receive, by the UE, an availability signal from the serving base station after execution of the program code executable by the computer for causing the computer to refrain, wherein the availability signal indicates to the UE that the configured time sensitive resource is available for transmission, wherein execution of the program code executable by the computer for causing the computer to autonomously transmit occurs after receipt of the availability signal.

A fifty-fourth aspect, based on the forty-ninth aspect, further including: program code executable by the computer for causing the computer to detect, by the UE, a collision of transmissions scheduled with another UE sharing the configured time sensitive uplink resource, wherein the configured time sensitive uplink resource includes the single shared resource; program code executable by the computer for causing the computer to determine, by the UE, a scheduled transmission time of the UE and the another UE; program code executable by the computer for causing the computer to determine, by the UE, in response to the scheduled transmission time being different, first transmission on the configured time sensitive uplink resource to the one of: the UE or the another UE scheduled for an earlier transmission; and program code executable by the computer for causing the computer to determine, by the UE, in response to the scheduled transmission time being a same time, the first transmission on the configured time sensitive uplink resource to the one of: the UE or the another UE having a higher access priority to the configured time sensitive uplink resource.

A fifty-fifth aspect, based on the forty-ninth aspect, further including: program code executable by the computer for causing the computer to select, by the UE, a time sensitive resource from the resource pool for transmission, wherein the time sensitive resource is selected using a hashing procedure known to the serving base station.

A fifty-sixth aspect, based on the forty-ninth aspect, further including: program code executable by the computer for causing the computer to receive, by the UE, a downlink trigger signal prior to execution of the program code executable by the computer for causing the computer to autonomously transmit: and program code executable by the computer for causing the computer to select, by the UE, a time sensitive resource from the set of resources using the downlink trigger signal, wherein each of a plurality of time sensitive resources of the set of resources is associated with a corresponding downlink trigger signal.

A fifty-seventh aspect, based on the fifty-sixth aspect, wherein the downlink trigger signal includes one of: a pre-configured waveform; a downlink control signal; or a FDM signal within a SSB transmission.

A fifty-eighth aspect, based on the forty-ninth aspect, further including: program code executable by the computer for causing the computer to receive, by the UE, a UE-specific downlink trigger signal prior to execution of the program code executable by the computer for causing the computer to autonomously transmit, wherein the UE-specific downlink trigger signal identifies a time sensitive resource from the set of resources for the program code executable by the computer for causing the computer to autonomously transmit.

A fifty-ninth aspect may include any combination of the forty-eighth aspect through the fifty-eighth aspect.

A sixtieth aspect configured for wireless communication includes a non-transitory computer-readable medium having program code recorded thereon, the program code including program code executable by a computer for causing the computer to configure, by a base station, one or more configured time sensitive uplink resources for time sensitive transmission; program code executable by the computer for causing the computer to transmit, by the base station, a configuration signal to at least one served UE, wherein the configuration signal includes identification of the one or more configured time sensitive uplink resources; program code executable by the computer for causing the computer to receive, by the base station, a time sensitive scheduling request from at least one served UE, wherein the time sensitive scheduling request indicates the at least one served UE will transmit time sensitive data on the one or more configured time sensitive uplink resources; and program code executable by the computer for causing the computer to receive, by the base station, the time sensitive data transmitted by the at least one served UE on the one or more configured time sensitive uplink resource.

A sixty-first aspect, based on the sixtieth aspect, wherein the one or more time sensitive configured time sensitive uplink resources includes one of: a single shared resource shared between two or more UEs of the at least one served UE; a resource pool shared between the two or more UEs, wherein the resource pool includes a plurality of uplink resources; and a set of resources shared between the two or more UEs.

A sixty-second aspect, based on the sixty-first aspect, further including: program code executable by the computer for causing the computer to receive, by the base station, a time sensitive scheduling request from a transmitting UE of the at least one served UE, wherein the configured time sensitive uplink resources include one of: the single shared resource or the resource pool.

A sixty-third aspect, based on the sixty-second aspect, further including: program code executable by the computer for causing the computer to transmit, at the base station, an unavailability signal to one or more other UEs of the at least one UE other than the transmitting UE, wherein the unavailability signal identifies the configured time sensitive uplink resources are unavailable.

A sixty-fourth aspect, based on the sixty-third aspect, wherein the unavailability signal includes one of: an uplink grant identifying the configured time sensitive uplink resource is unavailable; the uplink grant scheduling a new time sensitive resource for the one or more other UEs; the uplink grant scheduling the new time sensitive resource for the one or more other UEs and canceling configuration of the configured time sensitive uplink resource for the one or more other UEs; or a group common control signal identifying to the one or more other UEs the configured time sensitive uplink resource is unavailable.

A sixty-fifth aspect, based on the sixty-third aspect, further including: program code executable by the computer for causing the computer to transmit, by the base station, an availability signal the one or more other UEs after transmission by the transmitting UE, wherein the availability signal indicates to the one or more other UEs that the configured time sensitive resource is available for transmission.

A sixty-sixth aspect, based on the sixty-first aspect, further including: program code executable by the computer for causing the computer to select, by the base station, a time sensitive resource from the resource pool for receipt of the time sensitive data, wherein the time sensitive resource is selected using a hashing procedure known to a transmitting UE of the at least one served UEs.

A sixty-seventh aspect, based on the sixty-first aspect, further including: program code executable by the computer for causing the computer to transmit, by the base station, a downlink trigger signal to the at least one served UEs identifying a time sensitive resource for the time sensitive transmission, wherein each of a plurality of time sensitive resources of the set of resources is associated with a corresponding downlink trigger signal.

A sixty-eighth aspect, based on the sixty-seventh aspect, wherein the downlink trigger signal includes one of: a pre-configured waveform; a downlink control signal; or a FDM signal within a SSB transmission.

A sixty-ninth aspect, based on the sixty-first aspect, further including: program code executable by the computer for causing the computer to transmit, by the base station, a UE-specific downlink trigger signal prior to a transmitting UE of the at least one served UEs, wherein the UE-specific downlink trigger signal identifies a time sensitive resource from the set of resources for transmission of the time sensitive data by the transmitting UE.

A seventieth aspect may include any combination of the sixtieth aspect through the sixty-ninth aspect.

A seventy-first aspect configured for wireless communication may include at least one processor; and a memory coupled to the at least one processor, wherein the at least one processor is configured: to receive, at a UE, a resource configuration from a serving base station, wherein the resource configuration configures configured time sensitive uplink resources; to determine, by the UE, a time sensitive data for transmission; and to autonomously transmit, by the UE, the time sensitive data using the configured time sensitive uplink resources.

A seventy-second aspect, based on the seventy-first aspect, wherein the configured time sensitive uplink resources includes one of: a single shared resource shared between the UE and one or more additional UEs; a resource pool shared between the UE and the one or more additional UEs, wherein the resource pool includes a plurality of uplink resources; and a set of resources shared between the UE and the one or more additional UEs.

A seventy-third aspect, based on the seventy-second aspect, further including configuration of the at least one processor to transmit, by the UE, a time sensitive scheduling request to the serving base station after execution of the program code executable by the computer for causing the computer to determine the time sensitive data for transmission, wherein the configured time sensitive uplink resources include one of: the single shared resource or the resource pool.

A seventy-fourth aspect, based on the seventy-second aspect, further including configuration of the at least one processor: to receive, at the UE, an unavailability signal from the serving base station prior to execution of the configuration of the at least one processor to autonomously transmit, wherein the unavailability signal identifies the configured time sensitive uplink resources are unavailable; and to refrain, by the UE, from execution of the configuration of the at least one processor to autonomously transmit the time sensitive data in response to the availability signal, wherein the configured time sensitive uplink resources include one of: the single shared resource or the resource pool.

A seventy-fifth aspect, based on the seventy-fourth aspect, wherein the unavailability signal includes one of: an uplink grant identifying the configured time sensitive uplink resource is unavailable; the uplink grant scheduling a new time sensitive resource for the UE; the uplink grant scheduling the new time sensitive resource for the UE and canceling configuration of the configured time sensitive uplink resource for the UE; or a group common control signal identifying the configured time sensitive uplink resource is unavailable.

A seventy-sixth aspect, based on the seventy-fourth aspect, further including configuration of the at least one processor: to receive, by the UE, an availability signal from the serving base station after execution of the configuration of the at least one processor to refrain, wherein the availability signal indicates to the UE that the configured time sensitive resource is available for transmission, wherein execution of the configuration of the at least one processor to autonomously transmit occurs after receipt of the availability signal.

A seventy-seventh aspect, based on the seventy-second aspect, further including configuration of the at least one processor: to detect, by the UE, a collision of transmissions scheduled with another UE sharing the configured time sensitive uplink resource, wherein the configured time sensitive uplink resource includes the single shared resource; to determine, by the UE, a scheduled transmission time of the UE and the another UE; to determine, by the UE, in response to the scheduled transmission time being different, first transmission on the configured time sensitive uplink resource to the one of: the UE or the another UE scheduled for an earlier transmission; and to determine, by the UE, in response to the scheduled transmission time being a same time, the first transmission on the configured time sensitive uplink resource to the one of: the UE or the another UE having a higher access priority to the configured time sensitive uplink resource.

A seventy-eighth aspect, based on the seventy-second aspect, further including configuration of the at least one processor to select, by the UE, a time sensitive resource from the resource pool for transmission, wherein the time sensitive resource is selected using a hashing procedure known to the serving base station.

A seventy-ninth aspect, based on the seventy-second aspect, further including configuration of the at least one processor: to receive, by the UE, a downlink trigger signal prior to execution of the configuration of the at least one processor to autonomously transmit; and to select, by the UE, a time sensitive resource from the set of resources using the downlink trigger signal, wherein each of a plurality of time sensitive resources of the set of resources is associated with a corresponding downlink trigger signal.

An eightieth aspect, based on the seventy-ninth aspect, wherein the downlink trigger signal includes one of: a pre-configured waveform; a downlink control signal; or a FDM signal within a SSB transmission.

An eighty-first aspect, based on the seventy-second aspect, further including configuration of the at least one processor: to receive, by the UE, a UE-specific downlink trigger signal prior to execution of the configuration of the at least one processor to autonomously transmit, wherein the UE-specific downlink trigger signal identifies a time sensitive resource from the set of resources for the configuration of the at least one processor to autonomously transmit.

An eighty-second aspect may include any combination of the seventy-first aspect through the eighty-first aspect.

An eighty-third aspect configured for wireless communication may include at least one processor; and a memory coupled to the at least one processor, wherein the at least one processor is configured: to configure, by a base station, one or more configured time sensitive uplink resources for time sensitive transmission; to transmit, by the base station, a configuration signal to at least one served UE, wherein the configuration signal includes identification of the one or more configured time sensitive uplink resources; to receive, by the base station, a time sensitive scheduling request from at least one served UE, wherein the time sensitive scheduling request indicates the at least one served UE will transmit time sensitive data on the one or more configured time sensitive uplink resources; and to receive, by the base station, the time sensitive data transmitted by the at least one served UE on the one or more configured time sensitive uplink resource.

An eighty-fifth aspect, based on the eighty-fourth aspect, wherein the one or more time sensitive configured time sensitive uplink resources includes one of: a single shared resource shared between two or more UEs of the at least one served UE; a resource pool shared between the two or more UEs, wherein the resource pool includes a plurality of uplink resources; and a set of resources shared between the two or more UEs.

An eighty-sixth aspect, based on the eighty-fifth aspect, further including configuration of the at least one processor to receive, by the base station, a time sensitive scheduling request from a transmitting UE of the at least one served UE, wherein the configured time sensitive uplink resources include one of: the single shared resource or the resource pool.

An eighty-seventh aspect, based on the eighty-sixth aspect, further including configuration of the at least one processor to transmit, at the base station, an unavailability signal to one or more other UEs of the at least one UE other than the transmitting UE, wherein the unavailability signal identifies the configured time sensitive uplink resources are unavailable.

An eighty-eighty aspect, based on the eighty-seventh aspect, wherein the unavailability signal includes one of: an uplink grant identifying the configured time sensitive uplink resource is unavailable; the uplink grant scheduling a new time sensitive resource for the one or more other UEs; the uplink grant scheduling the new time sensitive resource for the one or more other UEs and canceling configuration of the configured time sensitive uplink resource for the one or more other UEs; or a group common control signal identifying to the one or more other UEs the configured time sensitive uplink resource is unavailable.

An eighty-ninth aspect, based on the eighty-seventh aspect, further including configuration of the at least one processor to transmit, by the base station, an availability signal the one or more other UEs after transmission by the transmitting UE, wherein the availability signal indicates to the one or more other UEs that the configured time sensitive resource is available for transmission.

A ninetieth aspect, based on the eighty-fifth aspect, further including configuration of the at least one processor to select, by the base station, a time sensitive resource from the resource pool for receipt of the time sensitive data, wherein the time sensitive resource is selected using a hashing procedure known to a transmitting UE of the at least one served UEs.

A ninety-first aspect, based on the eighty-fifth aspect, further including configuration of the at least one processor to transmit, by the base station, a downlink trigger signal to the at least one served UEs identifying a time sensitive resource for the time sensitive transmission, wherein each of a plurality of time sensitive resources of the set of resources is associated with a corresponding downlink trigger signal.

A ninety-second aspect, based on the eighty-first aspect, wherein the downlink trigger signal includes one of: a pre-configured waveform; a downlink control signal; or a FDM signal within a SSB transmission.

A ninety-third aspect, based on the eighty-fifth aspect, further including configuration of the at least one processor to transmit, by the base station, a UE-specific downlink trigger signal prior to a transmitting UE of the at least one served UEs, wherein the UE-specific downlink trigger signal identifies a time sensitive resource from the set of resources for transmission of the time sensitive data by the transmitting UE.

A ninety-fourth aspect may include any combination of the eighty-fourth aspect through the ninety-third aspect.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication, comprising:
receiving, at a user equipment (UE), a resource configuration from a serving base station, wherein the resource configuration configures configured time sensitive uplink resources;
determining, by the UE, a time sensitive data for transmission; and
autonomously transmitting, by the UE, the time sensitive data using the configured time sensitive uplink resources.

2. The method of claim 1, wherein the configured time sensitive uplink resources includes one of:
a single shared resource shared between the UE and one or more additional UEs;
a resource pool shared between the UE and the one or more additional UEs, wherein the resource pool includes a plurality of uplink resources; and
a set of resources shared between the UE and the one or more additional UEs.

3. The method of claim 2, further including:
transmitting, by the UE, a time sensitive scheduling request to the serving base station after the determining the time sensitive data for transmission, wherein the configured time sensitive uplink resources include one of: the single shared resource or the resource pool.

4. The method of claim 2, further including:
receiving, at the UE, an unavailability signal from the serving base station prior to the autonomously transmitting, wherein the unavailability signal identifies the configured time sensitive uplink resources are unavailable;
refraining, by the UE, from the autonomously transmitting the time sensitive data in response to the availability signal, wherein the configured time sensitive uplink resources include one of: the single shared resource or the resource pool.

5. The method of claim 4, wherein the unavailability signal includes one of:
an uplink grant identifying the configured time sensitive uplink resource is unavailable;
the uplink grant scheduling a new time sensitive resource for the UE;
the uplink grant scheduling the new time sensitive resource for the UE and canceling configuration of the configured time sensitive uplink resource for the UE; or
a group common control signal identifying the configured time sensitive uplink resource is unavailable.

6. The method of claim 4, further including:
receiving, by the UE, an availability signal from the serving base station after the refraining, wherein the availability signal indicates to the UE that the configured time sensitive resource is available for transmission, wherein the autonomously transmitting occurs after receipt of the availability signal.

7. The method of claim 2, further including:
detecting, by the UE, a collision of transmissions scheduled with another UE sharing the configured time sensitive uplink resource, wherein the configured time sensitive uplink resource includes the single shared resource;
determining, by the UE, a scheduled transmission time of the UE and the another UE;
determining, by the UE, in response to the scheduled transmission time being different, first transmission on the configured time sensitive uplink resource to the one of: the UE or the another UE scheduled for an earlier transmission; and
determining, by the UE, in response to the scheduled transmission time being a same time, the first transmission on the configured time sensitive uplink resource to the one of: the UE or the another UE having a higher access priority to the configured time sensitive uplink resource.

8. The method of claim 2, further including:
selecting, by the UE, a time sensitive resource from the resource pool for transmission, wherein the time sensitive resource is selected using a hashing procedure known to the serving base station.

9. The method of claim 2, further including:
receiving, by the UE, a downlink trigger signal prior to the autonomously transmitting; and
selecting, by the UE, a time sensitive resource from the set of resources using the downlink trigger signal, wherein each of a plurality of time sensitive resources of the set of resources is associated with a corresponding downlink trigger signal.

10. The method of claim 9, wherein the downlink trigger signal includes one of:
a pre-configured waveform;
a downlink control signal;
a frequency division multiple (FDM) signal within a synchronization signal block (SSB) transmission.

11. The method of claim 2, further including:
receiving, by the UE, a UE-specific downlink trigger signal prior to the autonomously transmitting, wherein the UE-specific downlink trigger signal identifies a time sensitive resource from the set of resources for the autonomously transmitting.

12.-23. (canceled)

24. An apparatus configured for wireless communication, the apparatus comprising:
at least one processor; and
a memory coupled to the at least one processor,
wherein the at least one processor is configured:
to receive, at a user equipment (UE), a resource configuration from a serving base station, wherein the resource configuration configures configured time sensitive uplink resources;
to determine, by the UE, a time sensitive data for transmission; and
to autonomously transmit, by the UE, the time sensitive data using the configured time sensitive uplink resources.

25. The apparatus of claim 24, wherein the configured time sensitive uplink resources includes one of:
a single shared resource shared between the UE and one or more additional UEs;
a resource pool shared between the UE and the one or more additional UEs, wherein the resource pool includes a plurality of uplink resources; and
a set of resources shared between the UE and the one or more additional UEs.

26. The apparatus of claim 25, further including configuration of the at least one processor to transmit, by the UE, a time sensitive scheduling request to the serving base station after execution of the program code executable by the computer for causing the computer to determine the time sensitive data for transmission, wherein the configured time sensitive uplink resources include one of: the single shared resource or the resource pool.

27. The apparatus of claim 25, further including configuration of the at least one processor:
to receive, at the UE, an unavailability signal from the serving base station prior to execution of the configuration of the at least one processor to autonomously transmit, wherein the unavailability signal identifies the configured time sensitive uplink resources are unavailable;
to refrain, by the UE, from execution of the configuration of the at least one processor to autonomously transmit the time sensitive data in response to the availability signal, wherein the configured time sensitive uplink resources include one of: the single shared resource or the resource pool.

28. The apparatus of claim 27, wherein the unavailability signal includes one of:
an uplink grant identifying the configured time sensitive uplink resource is unavailable;
the uplink grant scheduling a new time sensitive resource for the UE;
the uplink grant scheduling the new time sensitive resource for the UE and canceling configuration of the configured time sensitive uplink resource for the UE; or
a group common control signal identifying the configured time sensitive uplink resource is unavailable.

29. The apparatus of claim 27, further including configuration of the at least one processor:
to receive, by the UE, an availability signal from the serving base station after execution of the configuration of the at least one processor to refrain, wherein the availability signal indicates to the UE that the configured time sensitive resource is available for transmission, wherein execution of the configuration of the at least one processor to autonomously transmit occurs after receipt of the availability signal.

30. The apparatus of claim 25, further including configuration of the at least one processor:
to detect, by the UE, a collision of transmissions scheduled with another UE sharing the configured time sensitive uplink resource, wherein the configured time sensitive uplink resource includes the single shared resource;
to determine, by the UE, a scheduled transmission time of the UE and the another UE;
to determine, by the UE, in response to the scheduled transmission time being different, first transmission on the configured time sensitive uplink resource to the one of: the UE or the another UE scheduled for an earlier transmission; and
to determine, by the UE, in response to the scheduled transmission time being a same time, the first transmission on the configured time sensitive uplink resource to the one of: the UE or the another UE having a higher access priority to the configured time sensitive uplink resource.

31. The apparatus of claim 25, further including configuration of the at least one processor to select, by the UE, a time sensitive resource from the resource pool for transmission, wherein the time sensitive resource is selected using a hashing procedure known to the serving base station.

32. The apparatus of claim 25, further including configuration of the at least one processor:
to receive, by the UE, a downlink trigger signal prior to execution of the configuration of the at least one processor to autonomously transmit; and
to select, by the UE, a time sensitive resource from the set of resources using the downlink trigger signal, wherein each of a plurality of time sensitive resources of the set of resources is associated with a corresponding downlink trigger signal.

33. The apparatus of claim 32, wherein the downlink trigger signal includes one of:
a pre-configured waveform;
a downlink control signal;
a frequency division multiple (FDM) signal within a synchronization signal block (SSB) transmission.

34. The apparatus of claim 25, further including configuration of the at least one processor:
to receive, by the UE, a UE-specific downlink trigger signal prior to execution of the configuration of the at least one processor to autonomously transmit, wherein the UE-specific downlink trigger signal identifies a time sensitive resource from the set of resources for the configuration of the at least one processor to autonomously transmit.
